(19) United States
(12) Patent Application Publication
(10) Pub. No.: US 2008/0241334 A1
(43) Pub. Date: Oct. 2, 2008

(54) Method of freezing ice cream

(75) Inventor: Barnet L. Liberman, New York, NY (US)

Correspondence Address: COHEN, PONTANI, LIEBERMAN & PAVANE LLP, 551 FIFTH AVENUE, SUITE 1210, NEW YORK, NY, 10176, US

(73) Assignee: Barnet L. Liberman, New York, NY (US)

(21) Appl. No.: 12/077,703

(22) Filed: Mar. 20, 2008

Related U.S. Application Data
(60) Provisional application No. 60/921,028, filed on Mar. 30, 2007.

(51) Int. Cl. A23G 9/04

(52) U.S. Cl. 426/565

(57) ABSTRACT

Presented is a method of freezing ice cream. The method includes mixing a plurality of ingredients to produce soft ice cream, cooling the soft ice cream to a preliminary temperature between 19°-24° F. using a brine solution, pumping the cooled soft ice cream into a tube and then sealing the tube, disposing the sealed tube in a freezing sleeve and then sealing the freezing sleeve, and partially immersing the freezing sleeve in a brine solution until the ice cream is completely frozen.

### RELATED APPLICATIONS

This application claims priority from U.S. Provisional Patent Application Ser. No. 60/921,028 which was filed on Mar. 30, 2007.

### BACKGROUND OF THE INVENTION

1. Field of the Invention

The present invention relates to the manufacture of ice cream and, more particularly, to a process for expediting the freezing of ice cream to create smooth textured ice cream with a reduced level of butter fat.

2. Description of the Related Art

Ice cream stabilizers, locust bean gum, guar gum, carboxymethyl cellulose, sodium alginate, carrageenan, and xanthan, are ingredients commonly used in ice cream formulations. These ingredients are usually integrated with emulsifiers in the proprietary blends of ice cream of each ice cream manufacturer.

The primary purposes of using stabilizers in ice cream is to produce a product that has smoothness in body and texture, retard or reduce ice and lactose crystal growth during storage, and provide uniformity of the product and resistance to melting. Additionally, ice cream stabilizers are additives, which are used to stabilize the mix to prevent the separation of a clear liquid from the ice cream mass in the barrel or “wheying-off”, to produce a stable mixture with easy cut-off at a barrel freezer for packaging, and to slow down moisture migration from the product to the package or the air.

Control of “iciness” (the amount and size of ice crystals) in ice cream by stabilizers has been attributed to a reduction in the growth of ice crystals over time, which is related to a reduction in water mobility as water is entrapped by the entangled network structures of the stabilizers during the serum phase. Proper formulation of ice cream with stabilizers designed to combat against heat shock is an almost essential defense against the inevitable growth of ice crystals. Heat shock occurs when the ice cream undergoes large temperature fluctuations, which causes ice crystals to form. Low total solids mixes are also more difficult to effectively stabilize because the increased content of water leads to more ice at any given temperature.

The most frequently occurring textural defect in ice cream is the development of a coarse, icy texture. Iciness is also the primary limitation to the shelf life of ice cream and likely accounts for lost sales through customer dissatisfaction with ice cream quality.

In general, ice cream does not have an exact shelf life. Rather, the shelf life of ice cream is entirely a function of the storage conditions of the ice cream. Under good storage conditions, the shelf life of ice cream can be as much as one year. Under poor storage conditions, the shelf life of ice cream can be as little as two weeks or less. Although the source and contributing factors to the problem of iciness in ice cream are well known, an adequate solution has yet to be found.

The method that ice cream manufacturers have used to prevent iciness in ice cream has remained the same for some time and involves formulating the ice cream properly, freezing the ice cream quickly in a well-maintained barrel freezer, hardening the ice cream rapidly, and avoiding as much temperature fluctuation as possible during storage and distribution. Ice crystals need to be numerous and of small, uniform size so they are not detected when eaten. During the production process, heat shock due to large temperature fluctuations is the greatest cause of the loss of these small, uniform ice crystal size distributions, and results in a coarse, icy texture. However, obtaining optimum tasting ice cream based on the tight control of the foregoing parameters is not a simple task.

Ice crystals are relatively unstable, and during frozen storage, the ice crystals undergo changes in number, size, and shape (i.e., recrystallization), which is one of the most important reactions that leads to quality losses in all frozen foods. Some level of recrystallization occurs naturally at constant temperatures. However, the majority of recrystallization problems are created as a result of temperature fluctuations. For example, if the temperature during the frozen storage of ice cream increases, then some of the ice crystals become lost. In particular, the smaller crystals melt. As a result, the amount of unfrozen water in the serum phase increases. Conversely, as the temperature during the frozen storage of ice cream decreases, the water will refreeze but without re-nucleating. In this case, the water becomes deposited on the surface of the larger crystals in the ice cream. As a result, the total number of crystals diminish and the mean size of the crystals in the ice cream increases.

Temperature fluctuations are common in frozen storage as a result of the cyclic nature of refrigeration systems and the need for automatic defrosting. However, mishandling of the ice cream can also contribute to the degradation. The sight of ice cream sitting un-refrigerated on a loading dock, in the supermarket aisle, in a shopping cart, or in someone's grocery bag is all too common. Close study of the temperature history of ice cream during distribution, retailing, and finally consumption reveals a great number of temperature fluctuations. Each time the temperature changes, the ice to serum content changes, and the smaller ice crystals disappear while the larger ones grow even larger. Recrystallization is minimized by maintaining low and constant storage temperatures.

### SUMMARY OF THE INVENTION

A method of freezing ice cream is disclosed. The method is performed by mixing a plurality of ingredients to produce an ice cream mix, cooling the ice cream mix to a preliminary temperature between 19°-24° F. using a brine solution to produce soft ice cream, pumping the soft ice cream into a tube and then sealing the tube, disposing the sealed tube in a freezing sleeve and then sealing the freezing sleeve, and immersing the freezing sleeve in a brine solution until the soft ice cream is completely frozen and becomes hard ice cream.

According to another embodiment, a method of freezing ice cream is disclosed wherein the following steps are performed: mixing a plurality of ingredients to produce an ice cream mixture, cooling the ice cream mixture to a preliminary temperature between 19°-24° F. using a brine solution to produce a soft ice cream, disposing the soft ice cream into a plurality of at least one of a standard pint, quart, or other retail container, placing each of the plurality of at least one of a standard pint, quart, or other retail container in a mold that is disposed in a tray and arranging the tray such that each mold is immersed in a brine solution until the soft ice cream is completely frozen to produce hard ice cream.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

In the drawings, like reference characters refer to the same parts throughout the different views. Also, the drawings are not necessarily drawn to scale.

FIG. 1 is an illustrative flow diagram of a method for producing ice cream using a brine solution, according to one embodiment of the invention.

FIG. 2A is an illustrative side view of a pre-printed ice cream tube, according to one embodiment of the invention.

FIG. 2B is an illustrative perspective view of the pre-printed ice cream tube of FIG. 2A.

FIG. 3A is an illustrative side view of a freezing sleeve, according to one embodiment of the invention.

FIG. 3B is an illustrative perspective view of the freezing sleeve of FIG. 3A.

FIG. 4A is an illustrative top view of an ice cream shipping tray that includes twelve vertical freezing sleeves, according to one embodiment of the invention.

FIG. 4B is an illustrative side view of the ice cream shipping tray of FIG. 4A partially immersed in a brine solution.

FIG. 5 is an illustrative ice cream freezing tray that includes molds for standard ice cream containers, according to one embodiment, of the invention.

### DETAILED DESCRIPTION OF THE PRESENTLY PREFERRED EMBODIMENTS

In conventional methods for producing ice cream, ingredients including milk, flavorings, butter fat, and other additives, such as fruit, chocolate nuts, and the like, are mixed together to create an ice cream mixture or “mix” which is then cooled to a temperature of 22° F. to produce a soft ice cream. The rate of freezing to this “soft” point has an effect on the size of the crystals formed. At this temperature, the “soft” ice cream is pumped into individual containers to be “hard” frozen to a temperature of −20 to −40° F. This hard freezing may take in excess of 2 hours. Such a relatively slow final “hard freeze,” in addition to the slow initial freeze causes permanent formation of complex crystals, which reduces the “creamy” or “smooth” texture of premium ice creams. In conventional factories, the initial mixing and “soft” freeze is achieved using a batch or continuous cooling process which relies on a refrigerant, such as ammonia or Freon, to cool the outside of the mixing drum. The hard freeze is achieved using either blast freezers or spiral freezers. However, the hard freeze technique is a major determining factor in establishing the capacity of a production plant, because the hard freeze can be a bottle neck that limits the production flow.

The method for freezing ice cream, according to the present invention, involves a brine solution, such as the brine solution described in U.S. Patent Application Pub. No. 2002/0106443, the entirety of which is incorporated herein by reference. The brine solution is used to expedite the freezing of ice cream to create a smoother textured ice cream that has a reduced level of butter fat.

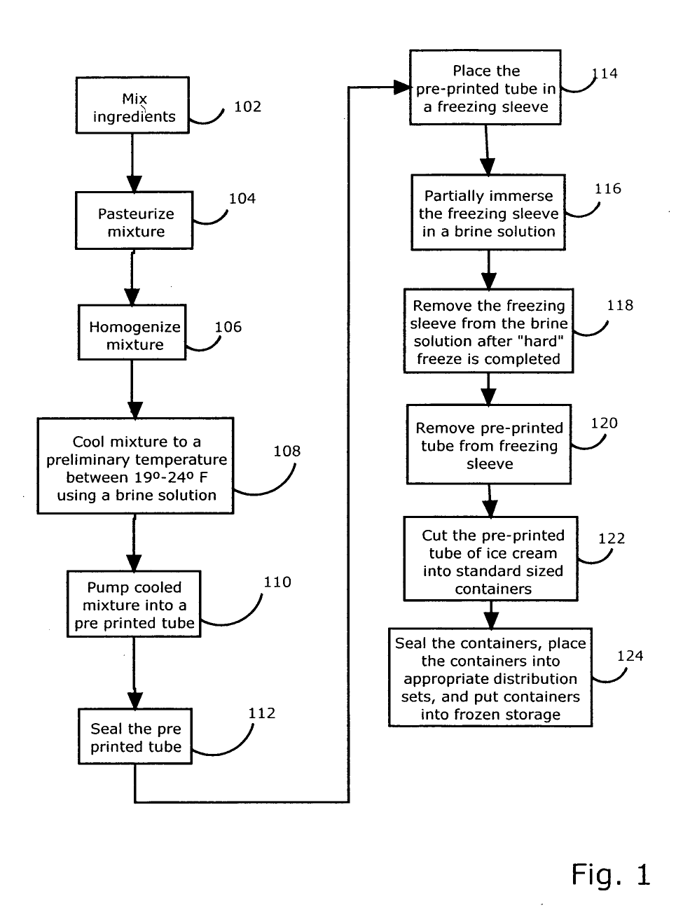

Referring to FIG. 1, an illustrative flow diagram of a method for producing ice cream using a brine solution is shown.

The method includes mixing all the necessary ingredients, such as flavors, additives, etc., to produce an ice cream mixture (Step 102). The mixture is then pasteurized (Step 104) and homogenized (Step 106) using methods known to those skilled in the art.

The ice cream mix is then cooled to a preliminary temperature between 19°-24° F. by the brine solution in a batch or continuous fashion (Step 108) to produce a soft ice cream. This process of using the brine solution in the initial “soft” freeze greatly reduces the complex crystal formation that is typically associated with conventional freezing methods that use the differential in temperature between the refrigerant circulating around the ice cream barrel mixer freezer and the ice cream ingredients to absorb the heat, and thereby lower the temperature of the ice cream.

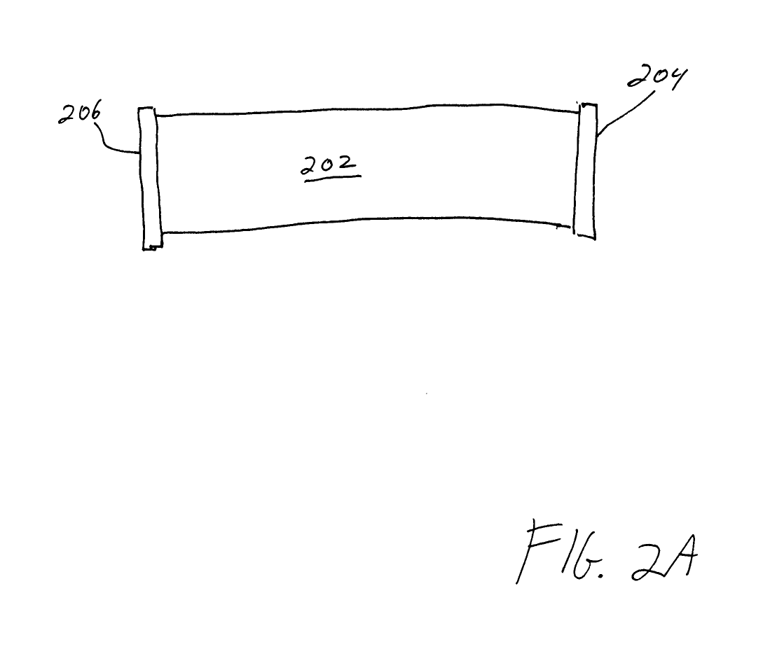

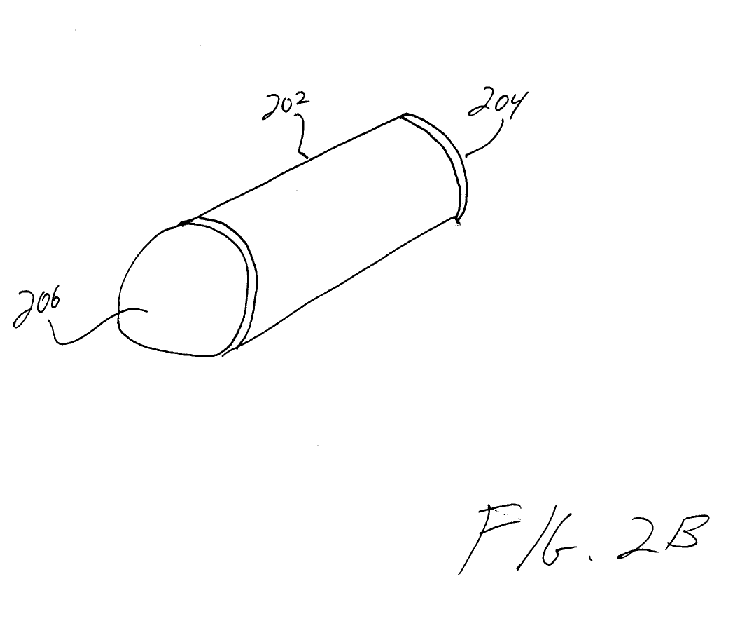

Referring to FIGS. 2A-2B, once the preliminary temperature of 19°-24° F. is reached, the soft ice cream is then pumped into a tube 202 that is closed at one end with a cap 204 (Step 110). This is the preferred method for half gallon or larger size containers. Upon filling the tube 202, a second cap 206 is used to completely close the tube 202 (Step 112). The tube 202 is a packaging tube preferably constructed of coated paper board or plastic and would also typically contain printing such as ingredients, flavor (e.g., vanilla, strawberry, etc.), producer's trademark, bar coding and other indicia.

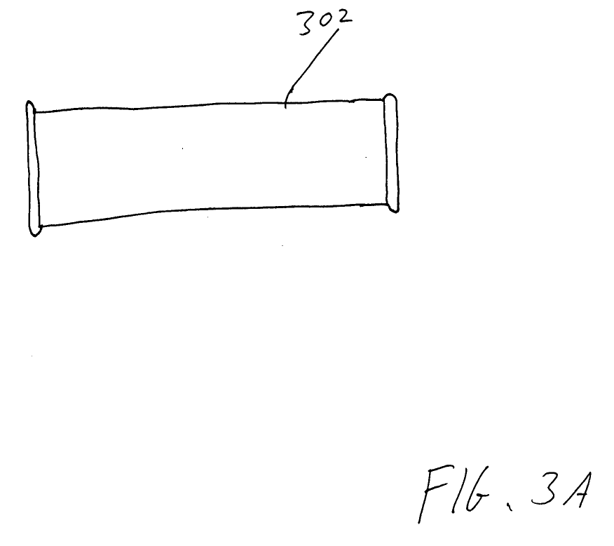

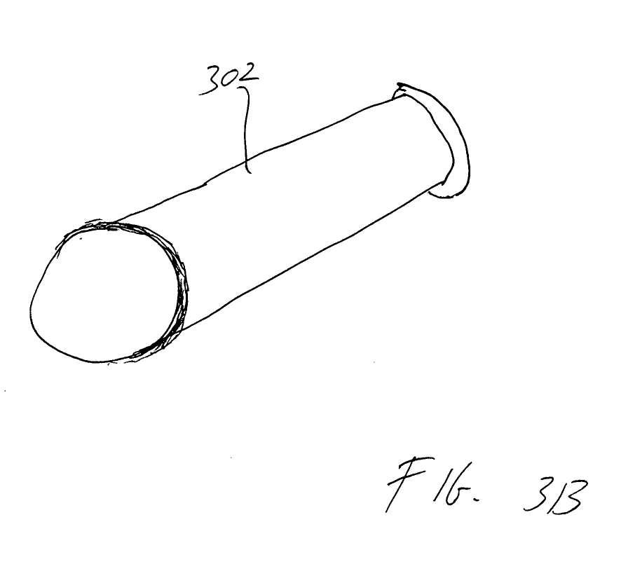

Referring to FIGS. 3A-3B, in one embodiment, the sealed tube 202 is then placed in a stainless steel tube or freezing sleeve 302 (Step 114). In other embodiments, the freezing sleeve 302 can be made of any other rust resistant material with a high coefficient of heat transfer. The freezing sleeve 302 is then sealed at both ends and partially immersed in the brine solution to thereby freeze the ice cream completely (Step 116).

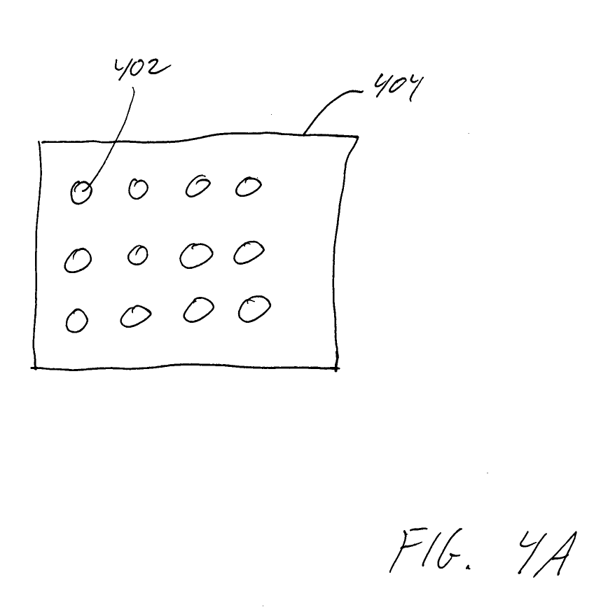

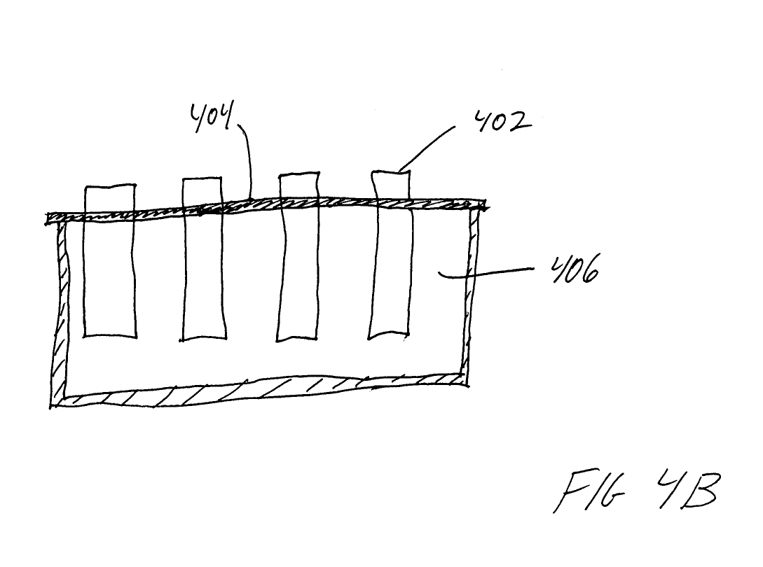

Referring to FIGS. 4A-4B, in another embodiment, several freezing sleeves 402 may be arranged vertically in a pattern in a shipping tray 404 that maximizes the flow of the brine around each tube. The freezing sleeves 402 are then partially immersed in a brine solution 406. The top of each freezing sleeve 402 extends approximately 2 or 3 inches above the brine solution 406 to promote the escape of heat and provide a way for the relief of pressure that is created by the quick freeze.

The brine immersion process, which occurs at a temperature of approximately −40° F., causes the ice cream to pass through the crystal forming temperatures rapidly. The heat generated by the soft ice cream as it changes from a liquid (26°-29° F.) to ice crystals (−25° F.) is absorbed much more quickly by the brine solution than with conventional freezing methods. The disclosed process greatly reduces the complex crystal formation that is typically associated with conventional freezing methods that use the differential in temperature between the air circulating around the ice cream containers and the soft ice cream to absorb the heat and thereby lower the temperature of the ice cream.

When the ice cream is hard frozen, the freezing sleeve 302 is removed from the brine, dipped and rinsed and/or wiped clean, and opened (Step 118). The resultant frozen ice cream in the tube 202 is removed from the freezing sleeves 302 (Step 120). The tube 202 of ice cream is placed in a guillotine that is used to cut the tube 202 of ice cream into standard or appropriately sized containers (Step 122). The containers are then capped, closed, and placed into appropriate distribution sets before being placed in frozen storage prior to shipment (Step 124).

The disclosed method reduces the time necessary to produce both the “soft” and the “hard” freeze states of the ice cream, which increases the capacity of a production plant, and reduces the power consumed by the plant. The disclosed process is applicable to a variety of different sized containers, such as 1 or 5 gallon containers, however, larger corrugated tubes and shipping tubes will be required and the dwell time of the ice cream in the brine will be increased.

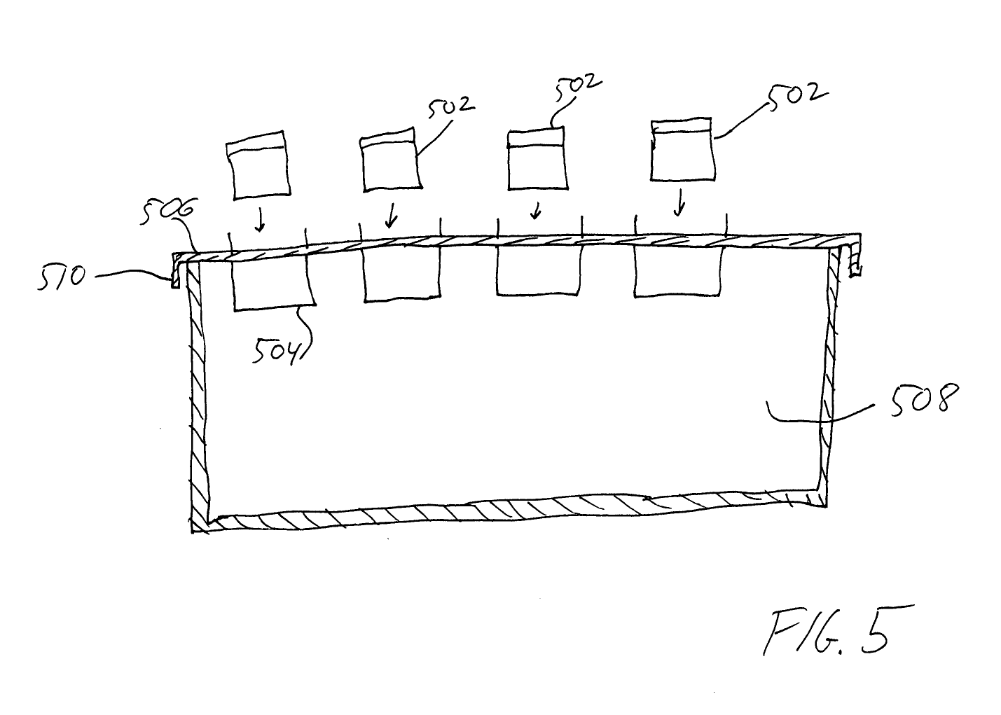

Referring to FIG. 5, in an alternative embodiment the ice cream mixture is inserted into a standard pint, quart, or other retail container 502. The container 502 is then inserted into a stainless steal or appropriate alternate mold 504 that is located in a tray 506 that is submerged in the brine 508. This permits the use of a shallower freezer, which results in a space saving within the production plant. The mold 504 possesses a high heat transfer coefficient and the tray 506 possesses a low heat transfer coefficient. The tray 506 is preferably constructed of plastic and also includes a lip 510 that extends around the perimeter of the tray 506 to prevent brine from being dripped onto the retail container 502 when the tray 506 is inverted to remove the retail container 502.

Consequently, at the end of the “hard” freeze cycle, the tray 506 with molds 504 for individual containers 502 may be inverted so that the individual containers 502 can be removed and shrink wrapped for “hard freeze” storage and distribution.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method of freezing ice cream, comprising:
mixing a plurality of ingredients to produce an ice cream mixture;
cooling the ice cream mixture to a preliminary temperature between 19°-24° F. using a brine solution to produce a soft ice cream;
placing the soft ice cream into a tube and then sealing the tube;
disposing the sealed tube in a freezing sleeve and then sealing the freezing sleeve; and
immersing the freezing sleeve in a brine solution until the soft ice cream is completely frozen to produce hard ice cream.

2. The method of claim 1, wherein the immersing step comprises partially immersing the freezing sleeve in the brine solution.

3. The method according to claim 1, further comprising pasteurizing the soft ice cream.

4. The method according to claim 1, further comprising homogenizing the soft ice cream.

5. The method according to claim 1, wherein the freezing sleeve comprises stainless steel.

6. The method according to claim 5, wherein the freezing sleeve comprises a rust resistant material.

7. The method according to claim 1, wherein a plurality of freezing sleeves are arranged vertically in a shipping tray.

8. The method according to claim 7, wherein the plurality of freezing sleeves are partially immersed in the brine solution.

9. The method according to claim 1 further comprising removing the tube from the freezing sleeve, cutting the tube into standard size containers, and sealing the standard sized containers.

10. The method of claim 1, wherein the disposing step is performed by pumping.

11. A method of freezing ice cream, comprising:
mixing a plurality of ingredients to produce an ice cream mixture;
cooling the ice cream mixture to a preliminary temperature between 19°-24° F. using a brine solution to produce a soft ice cream;
disposing the soft ice cream into a plurality of at least one of a standard pint, quart, or other retail container;
placing each of the plurality of at least one of a standard pint, quart, or other retail container in a mold that is disposed in a tray; and
arranging the tray such that each mold is immersed in a brine solution until the soft ice cream is completely frozen to produce hard ice cream.

12. The method according to claim 11, further comprising removing the plurality of at least one of a standard pint, quart, or other retail container from the molds.

13. The method according to claim 11, wherein the molds have a high heat transfer coefficient and the tray has a low heat transfer coefficient.

14. The method according to claim 11, wherein the molds each comprise stainless steel.

15. The method according to claim 11, wherein the tray comprises plastic.

16. The method according to claim 11, further comprising removing the tray from the brine solution and inverting the tray to remove each of the plurality of at least one of a standard pint, quart, or other retail container from the molds.

17. The method according to claim 16, wherein the tray comprises a lip that extends around the perimeter of the tray to prevent brine from dripping onto the plurality of at least one of a standard pint, quart, or other retail container when the tray is inverted to remove the plurality of at least one of a standard pint, quart, or other retail container.

18. The method of claim 11, wherein the disposing step is performed by pumping.

19. The method of claim 11, wherein the step of arranging the tray such that each mold is immersed in a brine solution comprises arranging the tray so that each mold is partially submerged in the brine solution.
